(19) United States
(12) Patent Application Publication
(10) Pub. No.: US 2007/0170158 A1
(43) Pub. Date: Jul. 26, 2007

(54) System and method for laser welding foils

(76) Inventor: Christian F. Greig, Westford, MA (US)

Correspondence Address: RATNERPRESTIA, P O BOX 980, VALLEY FORGE, PA, 19482-0980, US

(21) Appl. No.: 10/567,315

(22) PCT Filed: Aug. 13, 2004
(86) PCT No.: PCT/US04/26513

§ 371 Date: Dec. 13, 2006

Related U.S. Application Data
(60) Provisional application No. 60/501,337, filed on Sep. 9, 2003.

(51) Int. Cl. B23K 26/24

(52) U.S. Cl. 219/121.64; 219/121.83; 219/121.62

(57) ABSTRACT

A method and apparatus, for welding together a pair of metal foils of different thickness. The method includes the steps of positioning a thin metal foil adjacent a thick metal foil and applying a continuous wave laser beam to the thick metal foil to weld at least a portion of the thick metal foil and the thin metal foil together. A thermally conductive plate is positioned proximate the weld line in order to limit the thick foil melt pool and to function as a laser beam block. Accordingly, appropriate materials may be chosen for the foils and top plate so that the continuous wave laser beam couples optimally into the thick foil material and minimally into the top plate material. A thermocouple may be placed proximate the weld line to obtain measures of temperature used to vary the laser beam power and/or the slew rate.

### FIELD OF THE INVENTION

The present invention relates to the field of welding and, more particularly, to a method and system for welding together two or more metal foils.

### BACKGROUND OF THE INVENTION

FIG. 1 depicts a typical laser welding setup for laser welding together two metal foils of different thicknesses. As illustrated, a thin metal foil 102 is positioned on top of a thick metal foil 104. A laser 106 produces a pulsed laser beam 108 that is directed onto a top surface of the thin metal foil 102 along weld line 116. The laser beam 108 heats the thin metal foil 102 to its melting point, which, in turn, melts a portion of the thick metal foil 104 via conduction to form a “melt pool” containing metal from both metal foils 102, 104. In addition, the pulsed laser beam 108 effectively thrusts portions of the thin metal foil 102 into the thick metal foil 104. Moving the laser beam 108 allows the melt pool to cool, thereby binding the metal foils together.

A support plate 110 supports the metal foils 102, 104 and a weld plate 112 positioned on top of the thin metal foil 102 holds the metal foils 102, 104 in place. In addition, the weld plate 112 shields portions of the thin metal foil 102 from the laser beam 108 and acts as a heat sink to assist in controlling the portions of the thin metal foil 102 that melt during the welding process. The weld plate 112 typically includes a recess 113 for receiving a thermocouple (not shown) that acquires thermal readings during the welding operation.

The set up illustrated in FIG. 1, however, may produce undesirable welds. For example, the pulsed laser beam 108 may “punch” through the thin metal foil 102 and the thick metal foil 104 to produce imperfections, e.g., rough edges, on the surface of the thick metal foil 104 opposite the thin metal foil 102. In addition, a welding edge 114 of the top plate 112 may result in non-uniform welds in portions of the top plate 112 that the welding edge 114 deviates from a generally straight path, e.g., at a plate edge 118 or a thermocouple edge 120. These non-uniformities may result in pin-hole defects and discoloration of the foil materials due to thermal damage. The tensile strength of the weld may also be undesirably weak due to the ablation characteristics of the defects described above.

Additional defects may occur from a lack of stability and alignment of the laser beam as it moves along a desirable weld path. There may also be the lack of an adequate melt-pool, thereby leading to beading of the thin foil without drawing a desirable amount of material from the thick foil into the melt-pool to produce a desirable weld. Further, the use of pulsed lasers may introduce a lack of beam uniformity, and pulse-to-pulse stability, and may thereby cause pin-hole defects and thin foil material injecting inward resulting in an undesirably rough surface and an inadequate weld.

Imperfect and non-uniform welds are undesirable for certain applications, e.g., medical applications. For example, thin metal foil welds in devices for use within the human body, e.g., pace makers, must be free from rough edges to avoid rejection by the body. Therefore, welds that are uniform and free from imperfections are desirable for use in such applications.

### SUMMARY OF THE INVENTION

One embodiment of the present invention is method for welding together a first foil and a second foil by positioning the first foil having a first thickness adjacent the second foil having a second thickness, the first thickness being greater than or equal to the second thickness, and applying a laser beam to the first foil to weld at least a portion of the first foil and the second foil together. In a further embodiment, a high thermal conductivity top-plate is positioned adjacent the first foil.

In a further embodiment, the step of applying the laser beam includes activating a continuous wave high power direct diode laser with a predetermined wavelength and power along a predetermined weld line at a predetermined slew rate. Additionally, a measure of temperature proximate the predetermined weld line may be obtained to desirably vary the predetermined power and/or the predetermined slew rate of the laser. In another embodiment, the method is performed in the presence of an assist/process gas or while an assist/process gas is being blown proximate the weld line.

An additional embodiment of the present invention is a system for laser welding foils, the system including a continuous wave laser for applying a laser beam along a weld line on the foils, a thermally conductive plate with a continuous edge placed proximate the weld line, and a linear movement stage that moves either the laser or the foils so that the laser beam passes over the weld line at a predetermined slew rate.

A further embodiment includes a thermocouple placed within a recess of the thermally conductive plate for measuring the temperature proximate the weld line, and whereby a controller varies the slew rate and/or the power of the laser beam responsive to the temperature measurements. Additionally, the thermally conductive plate may have an angled edge to function as a laser beam block and/or reflector. In another embodiment, a process gas injection system is also included to supply a desirable process gas or blow the process gas along the weld line.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is perspective drawing of a prior art welding setup;

FIGS. 2a-b are perspective drawings of exemplary welding setups, in accordance with the present invention;

FIGS. 3a-c are perspective drawings of exemplary welding setups including exemplary thermally conductive plates, in accordance with embodiments of the present invention;

FIG. 4 is a perspective drawing of another exemplary welding setup including a thermally conductive plate, according to another embodiment of the present invention;

FIG. 5 is a top plan view of an exemplary thermally conductive plate, according to an embodiment of the present invention; and

FIG. 6 is a flow chart of exemplary steps for welding metal foils together in accordance with one embodiment of the present invention.

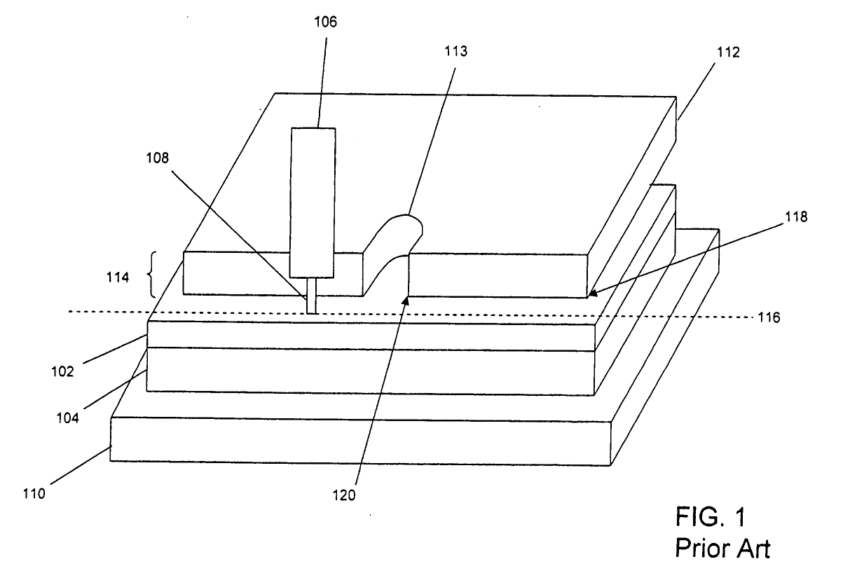

### DETAILED DESCRIPTION OF THE INVENTION

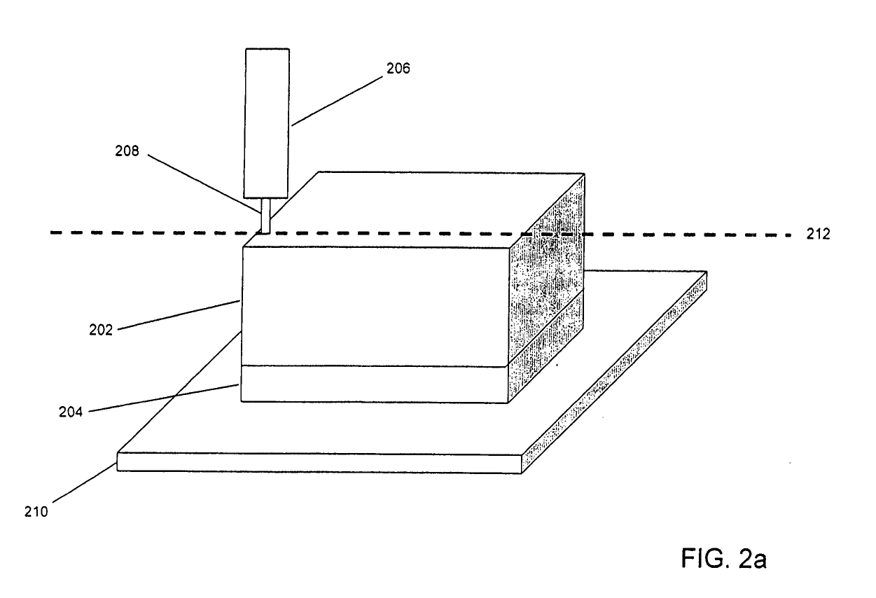

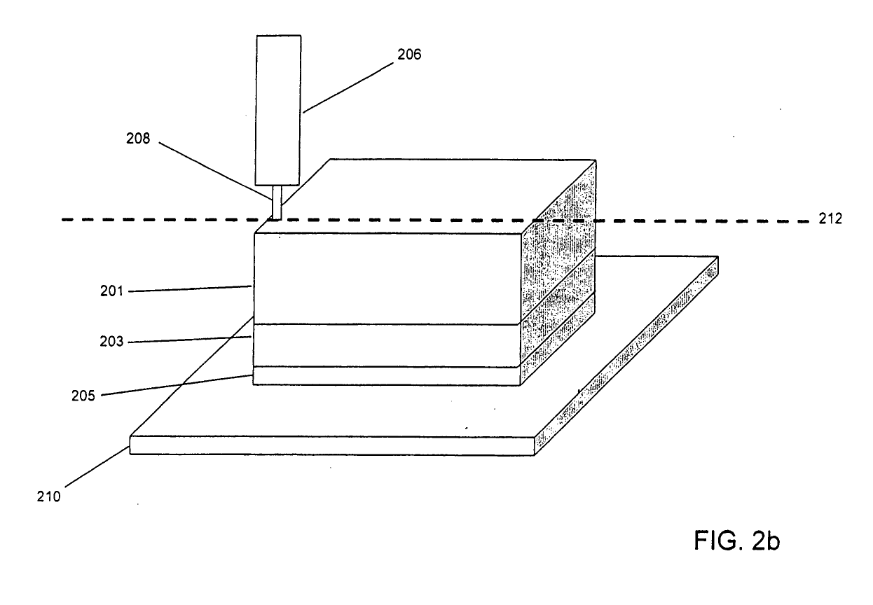

In FIG. 2a, an exemplary embodiment of the invention is shown as a welding setup including a top foil 202 positioned over a bottom foil 204. These foils are further positioned over support plate 210. To obtain an edge weld between top foil 202 and bottom foil 204, a laser 206 is used to apply laser beam 208 across weld line 212. Weld line 212 may be positioned, for example, at a distance from the edge of top foil 202 so that the diameter of the resulting melt pool does not substantially reach the edge, where it may cause an undesirable beading of the top foil material. Alternatively, the welding conditions may be controlled such that the melt pool reaches the edge of top foil 202, but does not bead excessively. Additionally, it is noted that the present exemplary welding setup may also be used with the weld line located in a central portion of the foils.

In their article MICRO-WELDING OF THIN FOIL WITH DIRECT DIODE LASER (Proceedings of SPIE Vol. 5063 Fourth International Symposium on Laser Precision Microfabrication, pgs. 287-291, 2003), Nobuyuki Abe, Yoshinori Funada, and Masahiro Ishide disclose an empirical finding for laser-welded butt joints that when the melt pool surface diameter exceeds approximately three times the foil thickness, the joint often fails due to excessive beading of the foil material. In the exemplary embodiment of FIG. 2a, top foil 202 is shown to have a greater thickness than bottom foil 204. It may be seen that having a thicker foil on the top may provide a greater thermal mass, thereby causing the thin foil on the bottom to be drawn into a melt pool formed from the application of laser beam 208. This selection allows the melt pool formed in top foil 202 to extend though top foil 202 and draw material from the full thickness of bottom foil 204 into the melt pool without its surface diameter exceeding three times thickness of top foil 202. It is noted that the present exemplary method may also work for foils having substantially equal thicknesses, or even in the situation where bottom foil 204 may be as much as about 150% the thickness of top foil 202.

In this exemplary embodiment, laser 206 may desirably be activated to apply laser beam 208 as a continuous wave having a constant fluence. The laser power and the spot size of the laser beam are desirably controlled to vary the fluence, though the spot size may also be varied to affect the melt pool diameter. The desired constant fluence is based on the foil thicknesses and the thermal properties of the foils. It is also noted that the fluence may be varied by varying the slew rate with which the beam spot is scanned along the weld line.

Alternately, laser beam 208 may be applied at a lower fluence at edge locations along weld line 212 that are located near the side edges of top foil 202, and ramped up to a predetermined steady-state fluence along locations of weld line 212 that are located at a distance from the side edges. The depth of these edge locations may vary depending on the thickness and/or thermal properties of the foil. For a typical thin metal foils (100-300 μm thick) these edge locations may extend about 1 mm from side edges of top foil 202.

The laser may desirably be operated at a wavelength that is substantially absorbed by the material used for top foil 202. For example, 808 nm light couples energy efficiently into steel.

In an exemplary embodiment of the present invention, laser 206 may be a High-Power Direct Diode Laser (HPDDL) or other continuous wave laser used for laser welding.

In one embodiment, laser 206 may be scanned along weld line 212 at a welding slew rate, where laser 206 is accelerated to the welding slew rate along a region of weld line 212 that is not incident on top foil 202. In an alternate embodiment, support plate 210 may be swept while laser 206 is held stationary so that the beam spot of the laser beam 208 passes over top foil 202 along weld line 212. This alternative scanning method may be desirable to allow mass manufacture in which foils are scanned one after another through the laser beam while traveling on a conveyor belt.

It is noted that the slew rate also affects to total fluence incident on a portion of the foil surface and, thus, the size of the melt pool formed. Therefore, the desired slew rate may be related to the desired laser power level and the desired spot size. Often the highest practical slew rate is desired to increase productivity.

In an experiment, two steel foils were laser welded using this exemplary equipment. Top foil 202 and bottom foil 204 were 150 microns and 100 microns thick, respectively, and had exemplary widths of 34 mm and exemplary lengths of 52 mm. Laser 206 was operated between 150 and 200 watts of output power and focused to a spot size of approximately 700 microns diameter. The slew rate was 35 mm/s.

It is noted that foils to be used in the exemplary embodiments of the present invention may be formed of one or more: metals such as copper, gold, silver, steel, aluminum, molybdenum, tungsten, iron, tantalum, and nickel; polymer materials; and plastic materials.

As is shown in FIG. 2b, an alternate embodiment of the invention includes top foil 201, intermediate foil 203, and bottom foil 205, wherein laser beam 208 may be applied as described above. In this exemplary embodiment, the thickness of top foil 201 may be greater than or equal to approximately two thirds of the sum of thicknesses of intermediate foil 203 and bottom foil 205. Additionally, it may be desirable for the thickness of intermediate foil 203 to be greater than or equal to the thickness of bottom foil 205. Those skilled in the art may recognize that a desirable melt pool formed according to the present invention may be large enough to allow for a plurality of foil layers to be welded together as described above.

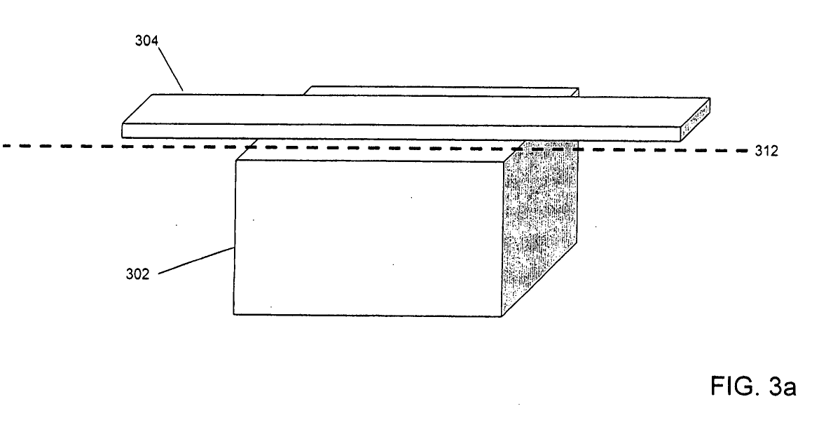

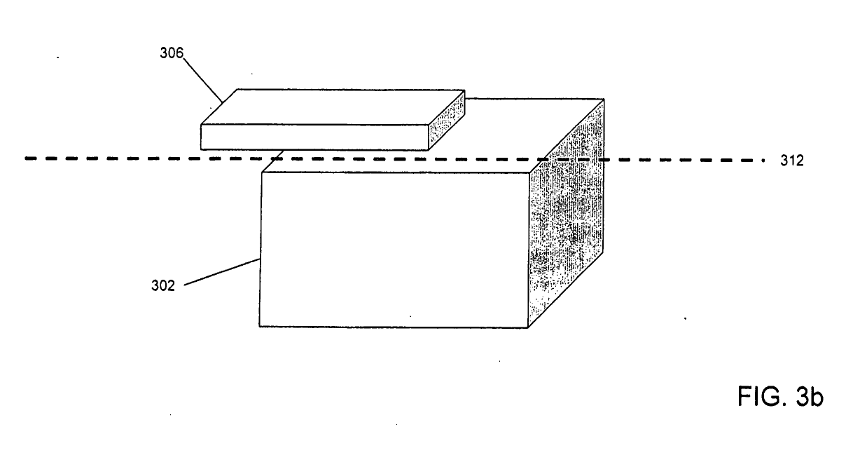

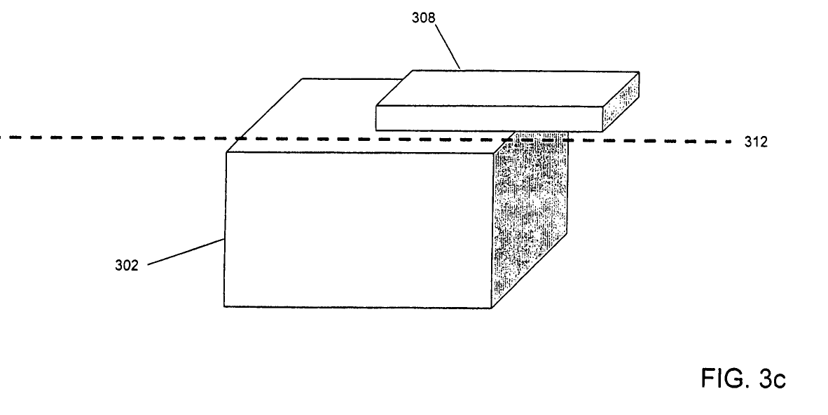

In a further embodiment of the invention, thermally conductive plate 304 may be placed proximate the weld line as shown in FIGS. 3a-c. This plate may be formed of a high thermal conductivity material such as a metal (e.g. copper, aluminum, etc.). Alternatively, it may be formed of materials such as ceramics or alumina, or a combination of these materials.

In FIG. 3a, thermally conductive plate 304 has a continuous edge proximate weld line 312, and is placed so that it overhangs both side edges of top foil 302 (no bottom foil is shown for simplicity). Such a configuration may provide heat sinking of the foil layers proximate to weld line 312, thereby controlling non-uniform heating effects of the laser (not shown) along weld line 312 and particularly at the edges of top foil 302. This may also allow additional control over the shape of the melt pool so that a melt pool of a given surface diameter may extend to a greater depth. Thermally conductive plate 304 may also increase the cooling rate of the welded joint. It is noted that thermally conductive plate 304 may also desirably compress the foil layers together to improve thermal transfer between the layers during the welding process.

FIG. 3b shows thermally conductive plate 306 overhanging only a first side edge of top foil 302, proximate weld line 312. Such a configuration may be used to apply a laser beam (not shown) to weld only a portion of top foil 302 to one or more bottom foils (not shown). FIG. 3c shows thermally conductive plate 308 placed on a second edge of top foil 312, thereby allowing a partial weld to be formed as described above, or the partial weld described above to be finished across the second edge. It is noted that for central lap welds, it may be desirable for two thermally conductive plates to be used, one on either side of the weld line, or one thermally conductive plate with an opening over the weld line.

Additionally, the laser beam may be generated by a continuous wave HPDDL at a predetermined wavelength and power along a weld line at a welding slew rate. Further, the thermally conductive plate may be placed proximate the weld line. The desired wavelength and power may be chosen based on the thicknesses and type(s) of foil material being welded, including the electromagnetic coupling wavelength and thermal characteristics of the foil material. In an exemplary embodiment, the foil material is 50-300 micron thick steel and the wavelength and power are 808 nm and 150-200 watts, respectively.

In a further embodiment, the laser beam may be applied at the predetermined slew rate by moving the first foil and the second foil on a linear movement stage along the weld line at the welding slew rate. Alternately, the beam spot of the laser beam may be moved on a linear movement stage to move the laser beam along the predetermined weld line. This may be accomplished optically, such as with rotating mirrors, or it may be accomplished mechanically by coupling the laser beam into an optical fiber and translating the output head of the fiber optical assembly. A combination of these two methods may be used to scan beam spot along the weld line.

In another embodiment, a thermocouple or other temperature sensor Imay be used to measure of the temperature of the foil(s) proximate to the weld line. A controller may then implement algorithms for varying the power, beam spot size, and/or the slew rate according to the measured temperature. For example, an increase in temperature beyond a predetermined threshold may prompt the controller to lower the laser power and/or to increase the slew rate or spot size. Alternately, a drop in temperature may cause the controller to increase the laser power and/or decrease the slew rate or spot size. Those skilled in the art will recognize that many alternate means for measuring a temperature may be used.

Additionally, the welding processes described above may take place in the presence of a process gas, or alternately while the process gas is blowing across the weld line. The process gas may desirably reduce oxidation, or other chemical activity, of the foil(s) during welding. Additionally, the process gas may help rapidly cool the foil(s) following the welding. The process gas may include, for example at least one of nitrogen, carbon dioxide, or a noble gas. It is also noted that the foils may alternatively be placed in a chamber of the process gas rather than having the process gas blown on them during welding.

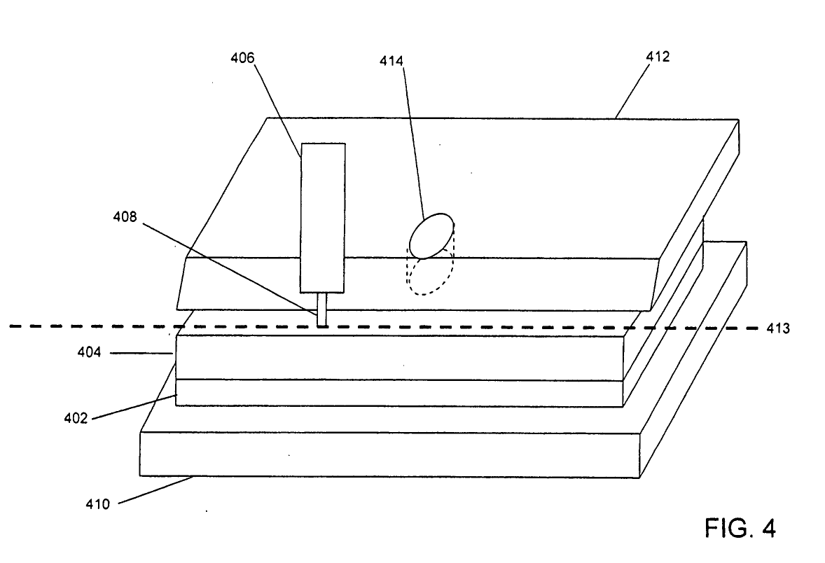

FIG. 4 depicts another exemplary welding setup 400 for welding bottom foil 402 and top foil 404 together. In general overview, a laser 406 produces a laser beam 408 that melts a portion of the top and bottom foils 404, 402 to form a melt pool that, when cooled, binds the bottom foil 204 and the top foil 404 together. A support plate 410 supports the foils 402, 404 and optional weld plate 412 secures foils 402, 404 in place during the welding operation.

The exemplary welding setup is now described in detail. In an exemplary embodiment, bottom foil 402 is a metal foil, such as steel foil, having of thickness of between approximately 50 microns and 1 mm, for example. In the exemplary embodiment, the top foil 414 may also be a metal foil such as steel having a thickness of between approximately 50 microns and 1.5 mm, for example. In another exemplary embodiment, the suitable ratio of bottom foil thickness to top foil thickness may be between approximately 0.25 and 1.5, for example. In an exemplary embodiment, the bottom and top foils 402, 404 are the same type of metal (e.g., steel). In an alternative exemplary embodiment, the foils may be formed of different materials.

The laser 406 produces laser beam 408 for welding together the top foil 404 and the bottom foil 402. In an exemplary embodiment, the laser may be a continuous wave (CW) laser that produces a continuous laser beam 408 with a substantially consistent energy output rather than a pulsed laser beam that is typically used in the art for welding metal foils. Using a CW laser may allow the power supplied to the top foil 404 to be carefully controlled such that energy from the laser beam 408 does not penetrate through both top foil 404 and bottom foil 402. In an exemplary embodiment, the power output of laser 406 is controllable to compensate for differences in the foil thicknesses, the foil types, and the rate at which the laser beam 408 moves relative to the surface of the top foil 404. In addition, the wavelength of the laser 406 is selected to ensure efficient coupling of the foils 402 and 404 during welding.

In one embodiment of the invention, laser 406 may be a Nuvonyx HPDDL having a 1000 watt fiber-coupled unit operating at 808 nm specifically terminating in a coaxial-gas assisted cutting head available from Nuvonyx, Incorporated of Bridgeton, Mo., USA. In an exemplary embodiment, this diode laser is operated between about 150 and 200 watts. In alternative exemplary embodiments, it is contemplated that a laser that produces a pulsed laser beam may be employed.

Further, a support structure or robot arm (not shown) may support the laser 406 and move the laser 406 and the support plate 410 relative to one another such that the laser beam 408 travels along a weld line 413 along the surface of top foil 404 during welding. Alternatively, this support structure or robot arm may be used to manipulate optics, possibly including fiber optics through which laser beam 408 has been coupled. Such a support structure may enable laser beam 408 to be positioned with six degrees of freedom (i.e., along orthogonal X, Y, Z axes with rotation around each axis) relative to top foil 404. In an exemplary embodiment, the support structure moves the support plate 410 and the laser 406 remains stable during welding. In an alternative exemplary embodiment, during welding, the support structure may move the laser 406 and the support plate 410 remain stable. In a further alternative embodiment, the support structure concurrently moves both the laser 406 and the support plate 410. A suitable support structure for use in the present invention will be understood by those of skill in the related arts.

Support plate 410 supports the bottom foil 402 and the top foil 404 for welding. Support plate 410 is sized to support at least the portions of the foils 402, 404 that are to be welded by the laser and, in the illustrated embodiment, supports the entire surface of the bottom foil 402 opposite the top foil 404. The support plate may desirably be formed of any solid material with a high enough melting point to remain unaffected by the welding process.

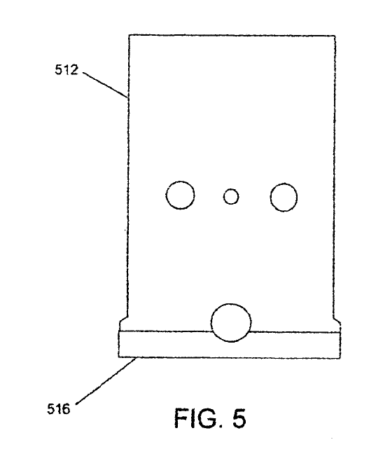

Additionally, FIG. 5a shows an optional weld plate 512 that may secure the bottom foil and the top foil together for welding. Additionally, weld plate 512 may act as a heat sink, a beam block, and/or a beam reflector. In an exemplary embodiment, the weld plate 512 is made from a good thermal conductor such as copper. The illustrated weld plate 512 is sized such that a weld edge 516 of the weld plate extends beyond side edges of a top foil when positioned on the top foil for welding.

In the illustrated embodiment of FIG. 5a, weld plate 500 includes a through hole 514 for receiving a temperature sensor, for example, a thermocouple (not shown), which enables the acquisition of thermal measurements to be made during welding. The through hole 514 is positioned such that continuous edge 516 of weld plate 512 is not interrupted. Thus, continuous edge 516 is continuous may allow better control of the welding process and reduce the formation of non-uniform welds. In a further embodiment, welding edge 516 may be sloped at an acute angle away from the weld line (as shown in FIG. 4). This sloped continuous edge may function as a beam block and/or reflector further controlling melt pool formation. It is noted that weld plate 512, or at least continuous edge 516, may desirably include a material that is substantially unaffected by the laser beam, such as a ceramic or alumina.

In an alternative exemplary embodiment, the setup depicted in FIG. 4 may be inverted with the bottom foil 402 being positioned on top of the top foil 404 and the laser beam 408 being directed upward onto the top foil 404. In accordance with this embodiment, the weld plate 412 is positioned under the top foil 404 to effectively become the support plate. The support plate 410 now positioned on top of the bottom foil 402 may then be optional.

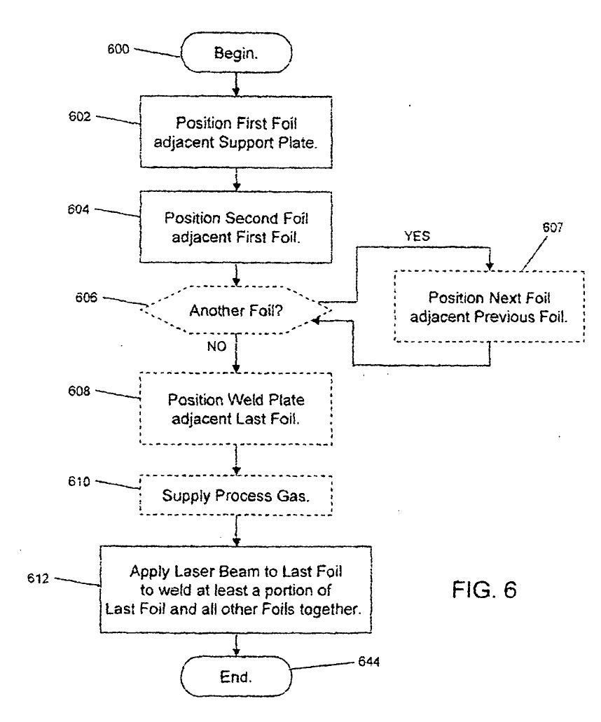

FIG. 6 depicts a flow chart 600 of exemplary steps for welding together a first foil having a first thickness and a second foil having a second thickness. Processing begins at block 602 with the positioning of the first foil and the support plate adjacent one another in a manner that will be understood by those of skill in the related arts.

At block 604, the second foil and the first foil are positioned on top of one another. In one embodiment, the front edge of the second foil is positioned such that it is substantially flush with a front edge of the first foil to form an edge weld when welded together. In an alternative embodiment, the front edges of the metal foils are offset with respect to one another to form a lap or tee weld when welded together.

At optional block 606 (shown in phantom), a decision may be made (during manufacture or prior to manufacture) to add one or more additional foils to the first two foils. A positive decision leads to block 607, which positions the next foil on top of the previous foil and transfers control back to block 606. These steps may be performed for any number of additional foils.

At optional block 608 (shown in phantom), a weld plate is positioned on top of the previously stacked foil to maintain the position of the previously stacked foil relative to all other foils beneath it and prevent buckling of the foils. As described above, the weld plate may also shield portions of the highest stacked foil from the laser beam and further may act as a heat sink to limit the amount of material drawn into a melt pool (i.e., the melt pool does not form under the weld plate).

In one embodiment, the front (desirably continuous) edge of the weld plate is positioned a minimum distance from the front edge of the highest stacked metal foil to allow formation of an adequate weld (e.g., a distance from the front edge of the highest stacked foil about two to four times total thickness of the stacked foils) up to essentially any distance that allows the top plate to remain in contact with the highest stacked foil while preventing buckling (e.g., about 12 mm or more).

In an alternative exemplary embodiment that does not include optional block 608, the laser beam produced by the laser may be controlled such that the foils do not buckle and/or bead. Thus, a heat sink and shield are not used. In this alternative embodiment, the weld plate may be anything capable of maintaining the positioned relationship of the metal foils and to prevent buckling, or may be eliminated (e.g., the weight of the highest stacked foil may be sufficient to maintain its position on the foil(s) beneath it and/or may be thick enough to prevent buckling).

At optional block 610 (shown in phantom), a process gas may be supplied to the welding environment surrounding the foils, and/or may be blown over the weld line.

At block 612, the laser beam irradiates the highest stacked foil to weld together at least a portion of the highest stacked foil and all foils beneath it. When the laser beam irradiates the highest stacked foil, the absorbed energy of the laser beam melts the highest stacked foil and, in turn, also melts the foils beneath. The melted portions of foils form a melt pool that, when cooled, binds them together.

During welding, the laser beam moves along the weld line on the surface of the highest stacked foil at a welding slew rate (e.g., 35 mm/sec). In an exemplary embodiment, the velocity of the beam spot of the laser beam relative to the highest stacked foil is ramped up (i.e., to the welding slew rate) and ramped down outside of the welding region (i.e., not on the surface of the highest stacked foil). Typically, the angle of incidence of the laser beam may be substantially normal to the surface of the highest stacked foil, however, it is contemplated that satisfactory results may be obtained by varying the angle at which the laser beam is applied to the highest stacked foil.

The process ends with block 644.

An increased process window may be achieved using an embodiment of the present invention due to the effectiveness of energy transfer from larger to smaller thermal masses. In addition, optimizing the melt characteristics of the thick metal foil may reduce defect rates due to ablation of the thin metal foil or beading of the melt pool due to surface tension.

Exemplary process parameters for welding thin and thick metal foils together using a 1000 Watt Fiber Coupled Diode laser are set forth in Table 1.

TABLE 1

| | |
|---|---|
| Laser Power | 166 watts |
| Input Current | 50% Maximum |
| Laser Beam Diameter at Foil Surface | Approximately 700 microns |
| Laser Beam Wavelength | 808 nm |
| Laser Beam Delivery Type | Fiber Coupled Cutting Head |
| Laser Beam Velocity | 35 mm/sec (laser beam velocity is |
| | ramped up and down outside of the |
| | welding region) |

Although the invention is illustrated and described herein with reference to specific embodiments, the invention is not intended to be limited to the details shown. For example, although an embodiment may depicts the foils positioned on top of a support with a laser beam directed downward onto the first foil, the foils may have essentially any orientation as long as they are positioned adjacent one another and the laser beam is directed at the first foil. Also, it is noted that in the exemplary figures of the present invention the weld lines are shown as straight merely for ease of illustration and are not intended to be limiting. Various other modifications may be made in the details within the scope and range of equivalents of the claims and without departing from the invention.

What is claimed:

1. A method for laser welding a first foil to a second foil, the method comprising the steps of:
a) providing the first foil having a first thickness and the second foil having a second thickness, the second thickness being less than about 150% of the first thickness;
b) positioning at least a portion of a bottom surface of the first foil in contact with at least a portion of a top surface of the second foil;
c) producing a beam spot on a top surface of the first foil using a laser welding system, at least a central region of the beam spot having sufficient fluence to form a melt pool that extends from the top surface of the first foil to the bottom surface of the first foil; and
d) scanning the laser beam spot along a weld line of the top surface of the first foil to weld the first foil to the second foil along the weld line.

2. A method according to claim 1, wherein step (a) includes the steps of:
a1) providing the first foil formed of at least of steel, aluminum, copper, gold, silver, molybdenum, tungsten, iron, tantalum, nickel, a polymer material, or a plastic material;
a2) providing the second foil formed of at least of steel, aluminum, copper, gold, silver, molybdenum, tungsten, iron, tantalum, nickel, a polymer material, or a plastic material.

3. A method according to claim 1, wherein step (b) further includes the step of positioning a thermally conductive top-plate in contact with the top surface of the first foil proximate to the weld line.

4. A method according to claim 1, wherein step (c) includes the steps of:
c1) generating a continuous wave laser beam, the continuous wave laser beam having a predetermined wavelength and a welding power; and
c2) focusing the continuous wave laser beam to the beam spot on the top surface of the first foil having a welding spot size.

5. A method according to claim 4, wherein:
step (c2) includes coupling the continuous wave laser beam into a fiber-coupled laser head; and
step (d) includes moving the fiber-coupled laser head parallel to the top surface of the first foil to scan the beam spot along the weld line.

6. A method according to claim 4, wherein step (d) includes scanning the beam spot along the weld line at a welding slew rate.

7. A method according to claim 6, wherein step (d) includes one of:
moving the first foil and the second foil at the welding slew rate so that the beam spot is scanned along the weld line on the top surface of the first foil; or moving the beam spot at the welding slew rate so that the beam spot is scanned along the weld line on the top surface of the first foil.

8. A method according to claim 6, wherein step (d) includes the steps of:
d1) detecting a temperature of the first foil proximate to the weld line; and
d2) varying the welding slew rate based on the temperature detected in step (d1).

9. A method according to claim 6, wherein:
the weld line extends from a first edge of the first foil to a second edge of the first foil;
step (d) includes varying the slew rate in portions of the weld line proximate to the first edge of the first foil and the second edge of the first foil.

10. A method according to claim 4, wherein step (c1) includes the steps of:
c1a) detecting a temperature of the first foil proximate to the weld line; and
c1b) varying at least one of the welding power and the welding spot size based on the temperature detected in step (c1a).

11. A method according to claim 4, wherein:
the weld line extends from a first edge of the first foil to a second edge of the first foil; step (c1) includes varying at least one of the welding power and the welding spot size in portions of the weld line proximate to the first edge of the first foil and the second edge of the first foil.

12. A method according to claim 1, wherein:
step (b) includes at least one of:
placing the first foil and the second foil in a process gas; or blowing the process gas over the at least a portion of the first foil proximate to the beam spot; and
the process gas is selected to reduce ambient chemical reactions of a material of the first foil during laser welding.

13. A method according to claim 12, wherein the process gas includes at least one of nitrogen, carbon dioxide, or a noble gas.

14. A system for laser welding a plurality of foils arranged in a stack, the system comprising:
a continuous wave laser for generating a laser beam;
optics for focusing the laser beam to a beam spot;
a foil holder including a thermally conductive plate that includes a continuous edge, the thermally conductive plate placed in contact with a top surface of a first foil of the plurality of foils to hold the plurality of foils such that the continuous edge is proximate to a weld line; and
a movement stage for scanning the beam spot of the laser beam along the weld line at a welding slew rate by moving at least one of;
the foil holder and the plurality of foils; or
the optics.

15. A system according to claim 14, wherein the foil holder further includes:
a temperature sensor thermally coupled to at least one of the plurality of foils for sensing a foil temperature proximate to the weld line; and
a controller for varying one or more of the welding slew rate and a power of the laser beam responsive to the foil temperature.

16. A system according to claim 15, wherein:
the thermally conductive plate includes a void proximate to the continuous edge; and
the temperature sensor includes a thermocouple placed within the void.

17. A system according to claim 14, wherein the continuous edge of the thermally conductive plate is sloped at an acute angle relative to the top surface of the first foil sloping away from the weld line.

18. A system according to claim 14, wherein the optics include an optical fiber and an output laser head.

19. A system according to claim 18, the movement stage includes an arm for positioning the output laser head such that the beam spot of the laser beam is focused and scanned along the weld line from a predetermined position relative to the first foil.

20. A system according to claim 14, wherein the continuous wave laser is a high power direct diode laser operated at a wavelength of approximately 808 nm and a power of between about 150 and 200 watts.

21. A system according to claim 14, wherein the continuous wave laser is operated at a wavelength selected to be substantially absorbed by the first foil.

22. A system according to claim 21, wherein the continuous wave laser is operated at a wavelength selected to be substantially reflected by the continuous edge of the thermally conductive plate.

23. A system according to claim 14, further comprising a process gas injector for one or more of:
blowing a process gas over the weld line in a region including the beam spot; or
surrounding the plurality of foils with the process gas.

24. A system according to claim 14, wherein the plurality of foils include at least cone of steel, aluminum, copper, gold, silver, molybdenum, tungsten, iron, tantalum, nickel, a polymer material, or a plastic material.

25. A system according to claim 14, wherein the thermally conductive plate includes at least one of copper, ceramic, or alumina.

26. A system according to claim 14, wherein:
a body of the thermally conductive plate is substantially formed of copper; and
the continuous edge of the thermally conductive plate is substantially formed of alumina.

27. A method for laser welding a first foil to a second foil, the method comprising the steps of:
a) providing the first foil having a first thickness and the second foil having a second thickness;
b) positioning at least a portion of a bottom surface of the first foil in contact with at least a portion of a top surface of the second foil;
c) positioning a thermally conductive plate including a continuous edge, a bottom surface of the thermally conductive plate being in contact with at least a portion of a top surface of the first foil;
d) producing a beam spot on the top surface of the first foil using a laser welding system, at least a central region of the beam spot having sufficient fluence to form a melt pool that extends from the top surface of the first foil to the bottom surface of the first foil; and
e) scanning the laser beam spot along a weld line of the top surface of the first foil to weld the first foil to the second foil along the weld line, the weld line being proximate to the continuous edge of the thermally conductive plate.

28. A method according to claim 27, wherein the first thickness is greater than or equal to the second thickness.

29. A method according to claim 27, wherein:
step (a) further includes providing a third foil having a third thickness;
step (b) further includes positioning at least a portion of a bottom surface of the second foil in contact with at least a portion of a top surface of the third foil; and
the sum of the second thickness and the third thickness being less than about 150% of the first thickness.

30. A method according to claim 27, wherein step (a) includes the steps of:
a1) providing the first foil formed of at least one of steel, aluminum, copper, gold, silver, molybdenum, tungsten, iron, tantalum, nickel, a polymer material, or a plastic material;
a2) providing the second foil formed of at least one of steel, aluminum, copper, gold, silver, molybdenum, tungsten, iron, tantalum, nickel, a polymer material, or a plastic material.

31. A method according to claim 27, wherein step (d) includes the steps of:
d1) generating a continuous wave laser beam, the continuous wave laser beam having a predetermined wavelength and a welding power; and
d2) focusing the continuous wave laser beam to the beam spot on the top surface of the first foil having a welding spot size.

32. A method according to claim 29, wherein:
step (d2) includes coupling the continuous wave laser beam into a fiber-coupled laser head; and
step (e) includes moving the fiber-coupled laser head parallel to the top surface of the first foil to scan the beam spot along the weld line.

33. A method according to claim 29, wherein step (e) includes scanning the beam spot along the weld line at a welding slew rate.

34. A method according to claim 33, wherein step (d) includes one of:
moving the first foil, the second foil, and the thermally conductive plate at the welding slew rate so that the beam spot is scanned along the weld line on the top surface of the first foil; or
moving the beam spot at the welding slew rate so that the beam spot is scanned along the weld line on the top surface of the first foil.

35. A method according to claim 33, wherein step (e) includes the steps of:
e1) detecting a temperature of the first foil proximate to the weld line; and
e2) varying the welding slew rate based on the temperature detected in step (e1).

36. A method according to claim 33, wherein: the weld line extends from a first edge of the first foil to a second edge of the first foil;
step (e) includes varying the slew rate in portions of the weld line proximate to the first edge of the first foil and the second edge of the first foil.

37. A method according to claim 29, wherein step (d1) includes the steps of:
d1a) detecting a temperature of the first foil proximate to the weld line; and
d1b) varying at least one of the welding power and the welding spot size based on the temperature detected in step (d1a).

38. A method according to claim 29, wherein:
the weld line extends from a first edge of the first foil to a second edge of the first foil;
step (d1) includes varying at least one of the welding power and the welding spot size in portions of the weld line proximate to the first edge of the first foil and the second edge of the first foil.

39. A method according to claim 27, wherein:
step (b) includes at least one of:
placing the first foil and the second foil in a process gas; or blowing the process gas over the at least a portion of the first foil proximate to the beam spot; and
the process gas is selected to reduce ambient chemical reactions of a material of the first foil during laser welding.

40. A method according to claim 39, wherein the process gas includes at least one of nitrogen, carbon dioxide, or a noble gas.
